(19) United States
(12) Patent Application Publication
(10) Pub. No.: US 2016/0295828 A1
(43) Pub. Date: Oct. 13, 2016

(54) Animal Litter Box

(71) Applicant: Mark J. Fenwick, River Bourgeois (CA)

(72) Inventor: Mark J. Fenwick, River Bourgeois (CA)

(21) Appl. No.: 15/090,934

(22) Filed: Apr. 5, 2016

Related U.S. Application Data
(60) Provisional application No. 62/144,933, filed on Apr. 9, 2015.

(51) Int. Cl. A01K 1/01

(52) U.S. Cl. CPC A01K 1/0107

(57) ABSTRACT

A litter box for an animal, typically a pet, comprises a base which holds a drain pan that contains litter. A drawer slides to and from the interior cavity of the base. The drawer holds a funnel and container, for receiving liquid pet waste from the drain pan. A hinged lid pivots downwardly from the front of the base, to rest on the top of the front end of the drawer where it projects from the front of the litter box. The lid provides a step for pet access to the drain pan.

This application claims benefit of provisional patent application Ser. No. 62/144,933 filed Apr. 9, 2015, the disclosure of which is hereby incorporated by reference.

### TECHNICAL FIELD

The present invention relates to devices which are familiarly called litter boxes, that is, to devices for receiving liquid and solid wastes of cats and other small pets.

Litter boxes provide places where small pets, particularly cats, can urinate and defecate while inside a dwelling. One familiar kind of litter box uses particulates of water absorbent clay such as bentonite, commonly called “cat litter.” Litter boxes require continual maintenance to avoid odors and encourage pet use. The urine causes the litter particles to swell and agglomerate. Solid waste is usually raked from the clumped litter and disposed of in a toilet, outdoors or in a municipal waste stream. While there are commercial litters which are marketed to alleviate the problem of odors, most users find they must often change the litter to avoid unpleasant odors. Cats often like to move the litter about after defecating, and upon repetitive use of a litter box, the cat will be undesirably pawing urine and feces filled litter, providing another incentive to replace the litter. Used litter is commonly disposed of by mixing it with trash or garbage, in that the hydrophilic clay can create a gooey mass if thrown in the yard, it is non-combustible, and it is not suitable for disposal in a sewage system, particularly an onsite treatment system.

As reflected in commerce and the patent literature, inventors and developers have employed various approaches to improve litter box functioning. In one approach, a non-absorbent particulate is employed as litter and it is placed in a structure having a perforated bottom. The urine flows through the perforated structure and into a collection container. U.S. Pat. No. 6,408,790 of Maguire and U.S. Pat. No. 8,887,667 also Maguire describe such a device. The disclosures of the foregoing patents are hereby incorporated by reference.

Other factors that influence a consumer's choice of litter box include convenience of use, ease of cleaning, cost, and “environmental friendliness.” Some inventors have provided litter boxes with trays which pull from beneath the box to ease cleaning. See U.S. Pat. No. 8,683,953 of Ramisch, U.S. Pat. No. 7,380,519 of Ikegami et al., and the Maguire patents. While the manner of making the litter box assemblies is not detailed in most litter box patents, we can reasonably presume from the details of the construction that they are most likely made of molded plastic and, as is well known, molds can be expensive.

### SUMMARY

Objects of the invention include providing a litter box device for use by cats and small animals, which device provides ease of use for the pet, ease of cleaning for the owner, ease of disposal of pet waste products, pleasing appearance, and attractiveness to the pet and owner. A further object is to provide a litter box which has low cost of manufacture and which enables economic shipping, that is, which is compact and light in weight when shipped.

In accord with the invention, an embodiment of litter box for use by an animal, typically a household pet, comprises a base, a drain pan mounted in the base, the pan having a perforated floor for holding particulate litter, and a drawer that slides through a front opening of the base, to and from the interior of the base, beneath the drain pan. The drawer holds a container for receiving liquid from a drain port of the drain pan; preferably, the liquid is channeled to the container by a funnel which is also carried in the drawer. The container and funnel are preferably positioned on a pedestal set within the drawer at a location which is spaced apart from one or both the front and the back of the drawer, to provide storage space for supplies within the drawer. Preferably, the pedestal is a box like structure. When the drawer is open, the funnel may be tilted upon the pedestal, to expose and enable removal for emptying of the liquid waste container.

When the drawer is fully inserted, i.e., closed, the litter box unit presents a clean and neat appearance. Any odor from the collected liquid waste in the container is minimized because the container has a small opening and is within the mostly closed-off base. Preferably the container is a rectangular cross section common waxed-paper container such are used for retail sale of juice, milk, etc.

Preferably, the front of the drawer extends beyond the front end of the base when the drawer is closed; and an optional lid that is hinged from the front surface of the base rests on the top of the extending portion of the drawer, thereby to close the front opening of the box, to keep the drawer in place, and to provide a step for the pet to access the litter which is held on the floor of the drain pan. In alternative embodiments, the drawer slides in and out of the base through an opening at the side or back of the base, with or without a lid.

The base, the drawer, the trays and the pedestal are preferably made of plastic or wax coated cardboard. Preferably the base is made of two pieces of cardboard that are mated. An optional canopy that is above the drain pan is preferably made of three pieces of flexible plastic, for convenient shipment.

The foregoing and other objects, features and advantages of the present invention will become more apparent from the following description of preferred embodiments and accompanying drawings.

### BRIEF DESCRIPTION OF THE DRAWINGS

FIG. 1 is a perspective view of a litter box embodiment of the present invention. The box has a canopy.

FIG. 2 is a side elevation cross section view of the box in FIG. 1.

FIG. 3 is a partial perspective view of the litter box shown in FIG. 1, with the drawer pulled from the base.

FIG. 4 is an exploded view of a litter box, mostly like that shown in FIG. 1 and FIG. 2.

FIG. 5 is a perspective view of a drain pan.

FIG. 5A is a perspective of an alternative drain pan.

FIG. 6 is a side cross section view of the pan in FIG. 5 with addition of a floor for holding litter.

FIG. 6A is a side cross section view of an alternative embodiment drain pan having a floor suspended within the pan by means of sides within the drain pan.

FIG. 7 is partial cutaway perspective view of a container and funnel showing how they set within a pedestal.

FIG. 7A is a perspective view of an alternative embodiment funnel.

FIG. 8 is a perspective view of a floor for a drain pan.

FIG. 9 is a perspective view of another embodiment of litter box of the present invention.

### DESCRIPTION

Certain parts of the present invention described below are preferably made of corrugated boxboard, a paperboard product of the kind familiarly used for shipping containers, which also referred to more generally as cardboard box material. Using cardboard as a material of construction provides an economic and environmentally friendly litter box. Preferably, the cardboard is treated with hot wax or a like substance to impart water resistance. In one process, often referred to as cascading, the interior is coated; such process is familiar in its use with cardboard shipping boxes for seafood and vegetables. In another process, often referred to as curtain-coating, the exterior of the cardboard structure is coated with a plastic material, usually clear. Optionally, the cardboard is waxed with a neutral or a cat-attractive scent coating. The exterior surfaces of the cardboard structures may be decoratively printed or painted. The parts described as being made of cardboard may be formed by alternative means, including by molding, welding, and/or adhesively attaching plastic materials.

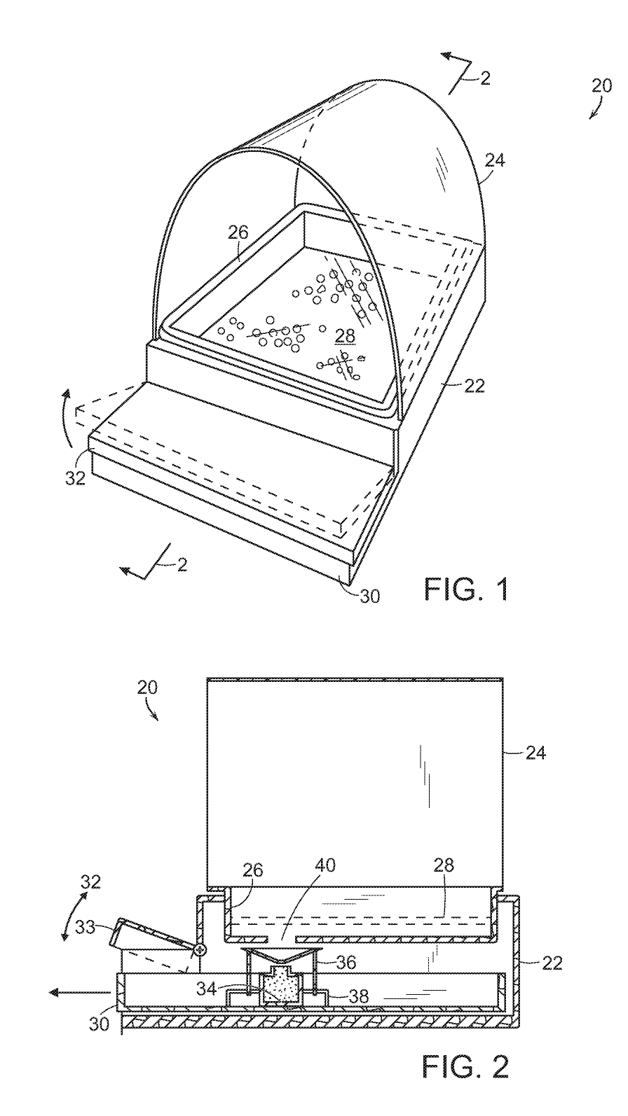

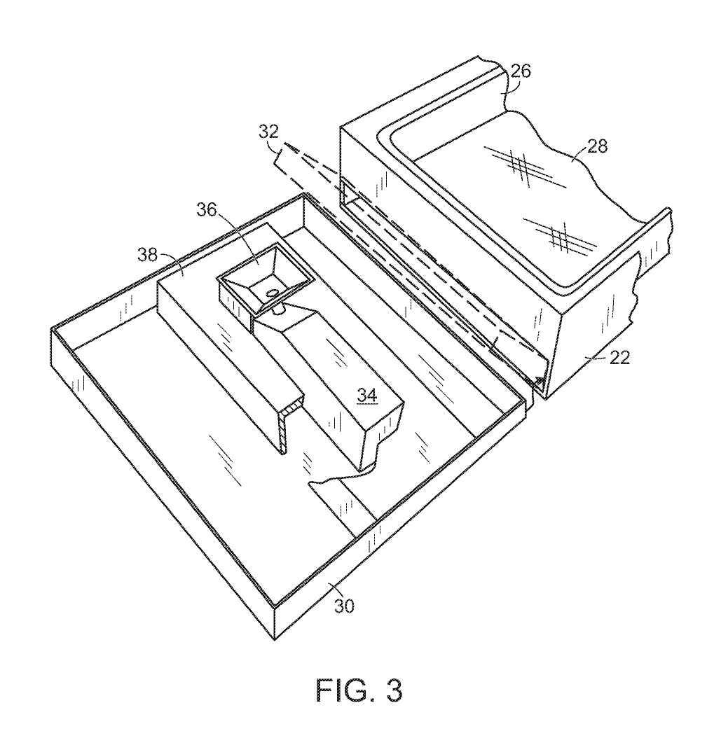

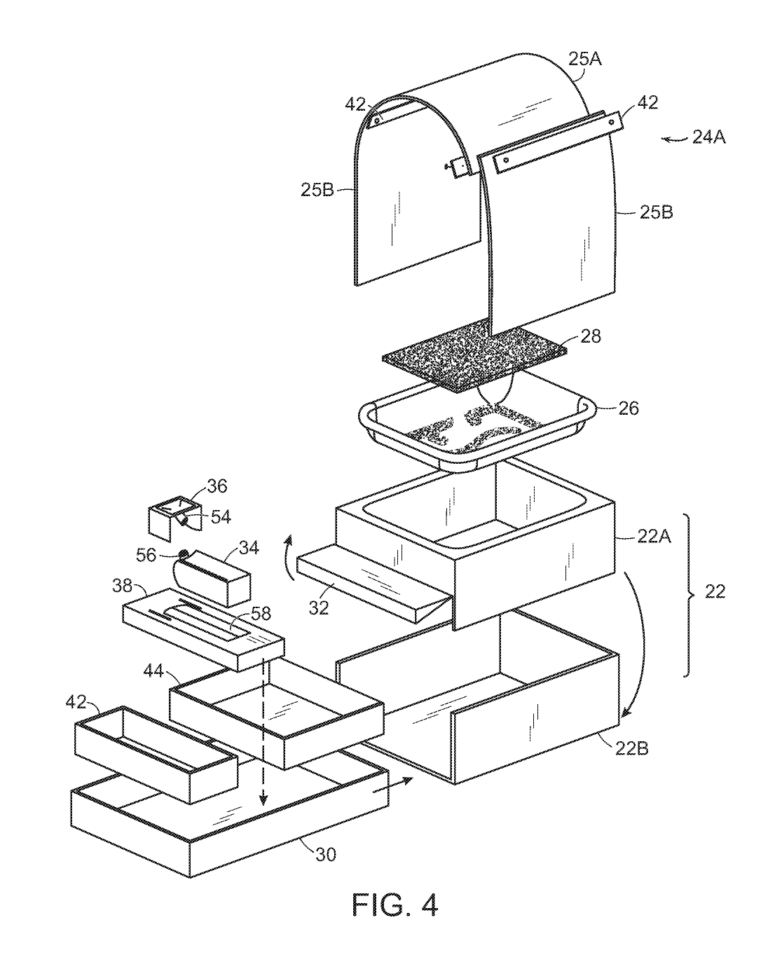

An embodiment of litter box 20 of the present invention is shown in the perspective view of FIG. 1, a somewhat simplified cross section of FIG. 2, and in the perspective part-view of FIG. 3. The box 20 is shown in exploded fashion in FIG. 4.

The box 20 comprises base 22 which holds drain pan 26 within which is perforated sheet floor 28. In an embodiment of the present invention, the drain pan may be about 55 cm long, 44 cm wide and 8.5 cm deep. The other elements of the box will be proportioned to the drain pan. Non-water absorbing litter (not shown) is placed on the surface of floor 28 when the box is put into use, to attract the cat or other pet to use it for defecating and urinating. The feces are caught amongst the litter and the liquid pet waste (urine) flows through the floor to the bottom of the pan 26, then through opening 40 in the pan 26 to funnel 36; then into a receptacle/container 34 which is held in a drawer 30.

The base of a litter box of the present invention preferably has walls at the front, back and sides, the exteriors of which are a substantially vertical; within the generality of such invention, exteriors may have modest inclines and curves.

Box 20 has an optional enclosure, namely canopy 24 which is preferably clear flexible plastic; the canopy provides an element of security and privacy (when decorated or not-clear) and helps to avoid scattering of litter. In FIG. 1, the canopy is shown as one piece. In FIG. 4, as discussed below, it is shown in multi-piece configuration.

As shown particularly in FIG. 4, box 20 comprises a base 22 which is preferably made of two mated pieces of cardboard 22A, 22B, as shown in FIG. 4. The pieces 22A, 22B may be glued, stapled, or otherwise attached to one another to form the base 22. In alternate embodiments the base may be one piece. In still other embodiments, when the box 20 is large, integral strengthening ribs may be formed as part of the cardboard base (as well as other cardboard parts).

Drawer 30 is slidable in and out of an opening at the front of the base from a pulled out position to a fully inserted position, also called the home position. There is a portion of base above the opening through which the drawer moves. The drawer also is preferably made of cardboard. In the embodiment of box 20 shown in FIG. 1 and FIG. 2, when the drawer is in the home position (also referred to as the drawer-closed situation) a portion of the drawer extends from the front face of the base so that the front of the box presents a stepped shape. The drawer in FIG. 2 is in the home position. The drawer in FIG. 3 is in fully pulled out position. When the drawer is in pulled out position functionally, a user can access and remove the container from the drawer.

Lid 32 is hinged from the front of the base, to rest on the front edge of drawer 30 when the drawer is in its home position. See FIG. 1 and FIG. 2. When the lid is hinged-down and closed, the top surface of lid 32 provides a step surface that is intermediate in elevation between the top of the base and the bottom of the base (which in use normally sets on a dwelling floor or other support surface) thereby easing animal access to the litter in the drain pan. Lid 32 preferably has a lip 31 which captures the outer end of the drawer to keep it in the home position. Alternatively, there is no lip 31. The hinge for the lid may be of the so-called living hinge type, essentially integral with the front wall of the base; other known kinds of hinges may be used.

In a variation from what is shown in FIG. 1 and FIG. 2, the drawer and lid may be configured so that when the lid is at rest on the front end of the drawer the lid surface is sloping downwardly from the hinge point. Optionally, the lid may have a roughened or grit-containing coating to provide gripping surface for animal paws and to inhibit scattering further such litter as the animal inadvertently ejects from floor/drain pan during use of the litter box.

In another alternative embodiment of the invention, not shown but easily conceived, the front of drawer 30 in the home position is flush with the front surface of the base that is above the drawer opening, and there is no lid and step. In still other alternative embodiments, the drawer—with or without extension beyond the adjacent vertical wall of the base—may slide in and out through an opening which is at a side or at the rear of the base 22, instead of at the front as shown.

Pedestal 38 is at a mid-length location of the drawer 26. Pedestal 38 is box-like and has a top shaped as a rectangular tray having a cutout. Preferred pedestal 38 is configured to hold funnel 36 and laterally to restrain container 34. Pedestal 38 preferably has a rectangular opening 58 at its top, within which is received and suitably located container 34, relative to the drawer and to the funnel, or relative to the drain port of the drain pan in an embodiment which does not employ a funnel.

FIG. 7 is a partial cutaway view of pedestal 38, showing how funnel 36 mounts on pedestal. The preferred funnel has opposing side legs 50, the tab-ends 51 of which slip into slots of the pedestal top. To remove the container, the funnel may be tilted in the direction transverse to the front-back direction of the drawer with the legs in the slots, or the funnel may be removed by lifting vertically.

The function of the funnel is to make less critical the alignment of the spout 56 of container 34 with the discharge port 40 of the drain pan. The funnel has a conical interior portion 52 which channels liquid received from the drain pan to output port 54. Port 54 is fitted into the spout 56 of container 34.

The funnel may be mounted on the pedestal by other means than by the aforementioned tabs. For instance, as shown in FIG. 7A, funnel 136 with port 154 has opposing side stepped legs 150, the bottommost tabs 151 of which engage the fore-aft sides of the pedestal. Tabs 151 enable tilting of the funnel or removal of the funnel from the pedestal. In still another alternative, the funnel may be clamped or screwed to the pedestal.

In another embodiment of funnel, the structure which comprises the funnel legs may be a separate structure from the cone of the funnel itself; or uprights integral with the pedestal may project upwardly to provide supporting structure for holding the funnel in substitution of legs.

Fore and aft of the pedestal within the drawer are optional trays 42, 44, shown only in FIG. 4. The trays 42, 44 fit in spaces which are fore and aft of the pedestal. See the spaces in FIG. 2. The pedestal and trays are preferably made of cardboard, preferably as described above.

The space in the drawer which is fore and aft of the pedestal—whether trays are used or not—may be used for storage of replacement litter or supplies associated with cat care. When present, the trays are shaped so that they locate the pedestal and funnel along the front-back length of the drawer. When the drawer is in its home position, the funnel is beneath the drain port of the drain pan. In embodiments of the litter box of the present invention, when there are no trays, pedestal 38 may be held in position within the drawer by means such as struts or brackets, cooperating engagement features of the drawer and pedestal, and such as clips, tabs, bands, staples, etc.

Container 34 is preferably a commercial wax-board juice container, such as is used for products sold in retail stores. Funnel 36 mounts on the pedestal 38 and channels liquids into the container 34. The relatively small spout and associated opening that characterizes the aforementioned kind of commercial juice container, as illustrated, means that there will be limited evaporation and resultant odor from collected liquid waste (urine), compared to having an open container, or compared to the urine being only collected in the bottom of the drain pan 26. In the generality of the invention, the container is rectangular or round or non-round in cross section and has an opening which is disposed for liquid flow communication with the port of the drain pan when the drawer is in the home position. Optionally, the container may be fitted with a liquid level sensor or a weight sensor, so the owner is signaled when it is time to empty the container.

The apparatus configuration enables the funnel may be easily cleaned when needed and enables the container to be conveniently removed and replaced. Referring again to FIG. 1-4, when the drawer is pulled from the base sufficiently to expose the funnel 36 and container 34, the funnel may be tilted in a direction which is transverse to the length of the drawer to slide the legs upwardly from the slots in the pedestal, or the funnel may be simply lifted vertically. Next, container 34 may be removed from its nested place within the pedestal and taken away to be emptied. Alternatively, when feasible, the container may be disposed of with its contents and replaced with a new container. Optionally, the pedestal and/or container may be fitted with handles or straps for ease of removal and handling.

An advantage of the present invention is that the container can be one that is recycled from its use as juice packaging, lowering the user's cost. In alternative embodiments of the invention, a container (other than the aforementioned recycled juice container) having an attached or integral funnel may be employed. In a still further alternative embodiment, the funnel may be omitted and the container may be provided with an opening sufficiently sized to receive liquid from the port of the drain pan without spillage, notwithstanding there is some disadvantage in that a larger opening can let odors and vapors escape from the container more than occurs with the preferred embodiment container.

While the above-described configuration of pedestal 38 is preferred, other embodiments of pedestal may be used: the term pedestal in the claims herein shall comprehend any structure configured for holding in place a container within the drawer, optionally with a funnel mounted above the container. For example, the container may be restrained from fore-aft and sideways movement by ridges or cleats on the bottom of the drawer. For example, the container may be held in place by detachable elastic bands or detachable light clamps. For example, the funnel could be restrained from movement by its engagement with the restrained container rather than both elements being separately engaged with the pedestal.

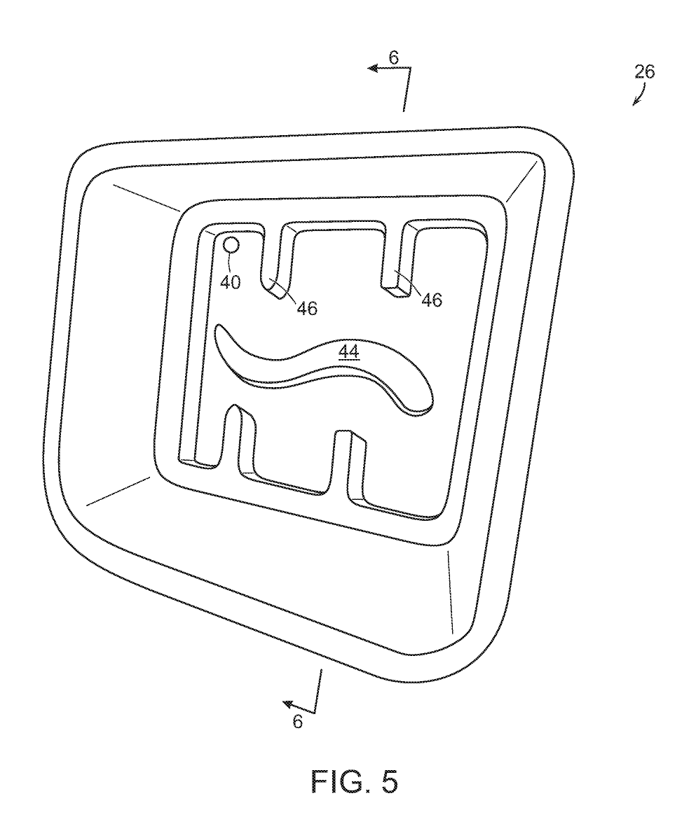

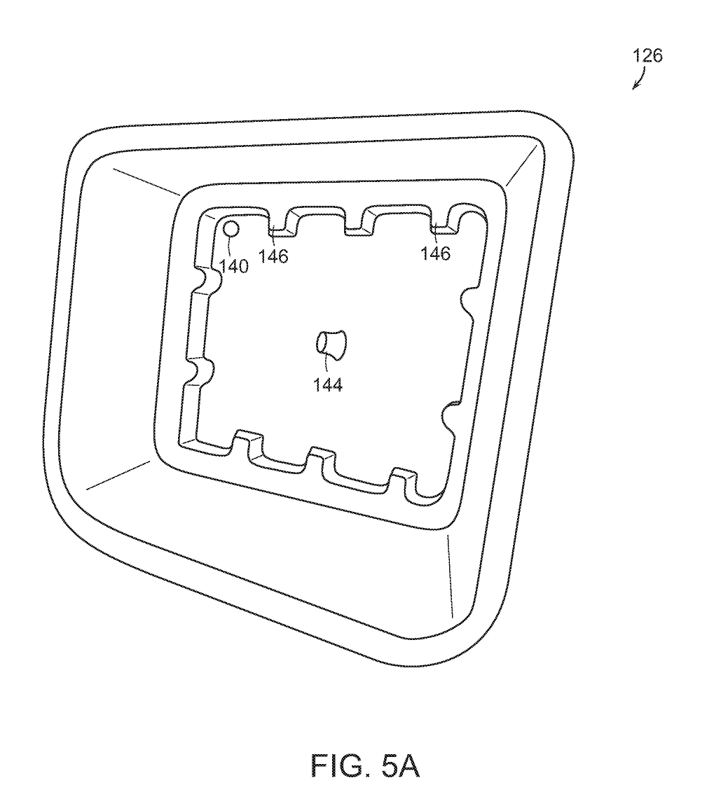

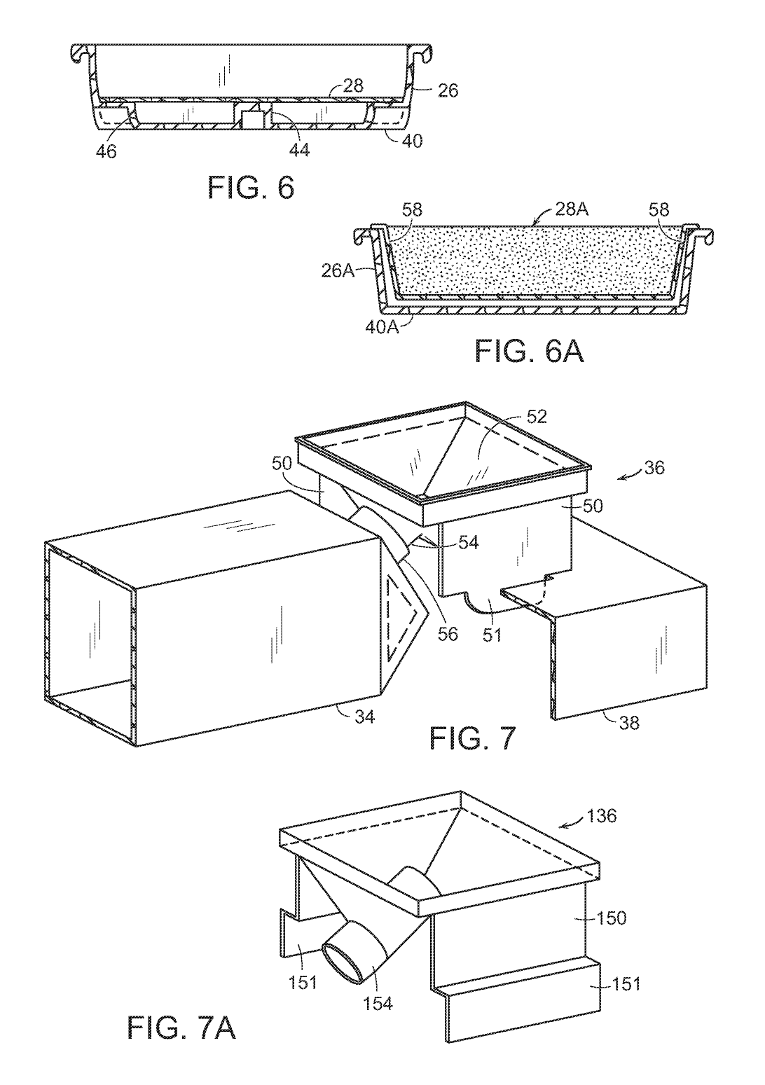

FIG. 5 is a perspective view of an embodiment of drain pan 26, showing how the pan bottom comprises lands 46, 44 and a drain port 40. FIG. 6 is a cross section of drain pan 26. The bottom of the pan is preferably sloped slightly when the drain pan sets within the opening of the base, so that liquid flows toward the port 40.

FIG. 6 shows the addition of a flat perforated floor panel 28 which is supported by the top surfaces of the lands 44, 46. A floor panel is optional, but preferred. The floor panel holds the litter, better allowing liquid waste to flow to the drain port 40. An advantage of the configuration of drain pan 26 is that it has ease of cleaning. Alternative features for supporting the floor panel and providing drainage to the drain port 40 may be used. In an alternative embodiment of the invention, the floor panel may have other configurations, including that it may have downwardly-projecting ribs or pins for supporting the panel on a flat floor of a drain pan. In a still further alternative, small separate spacer blocks may be used.

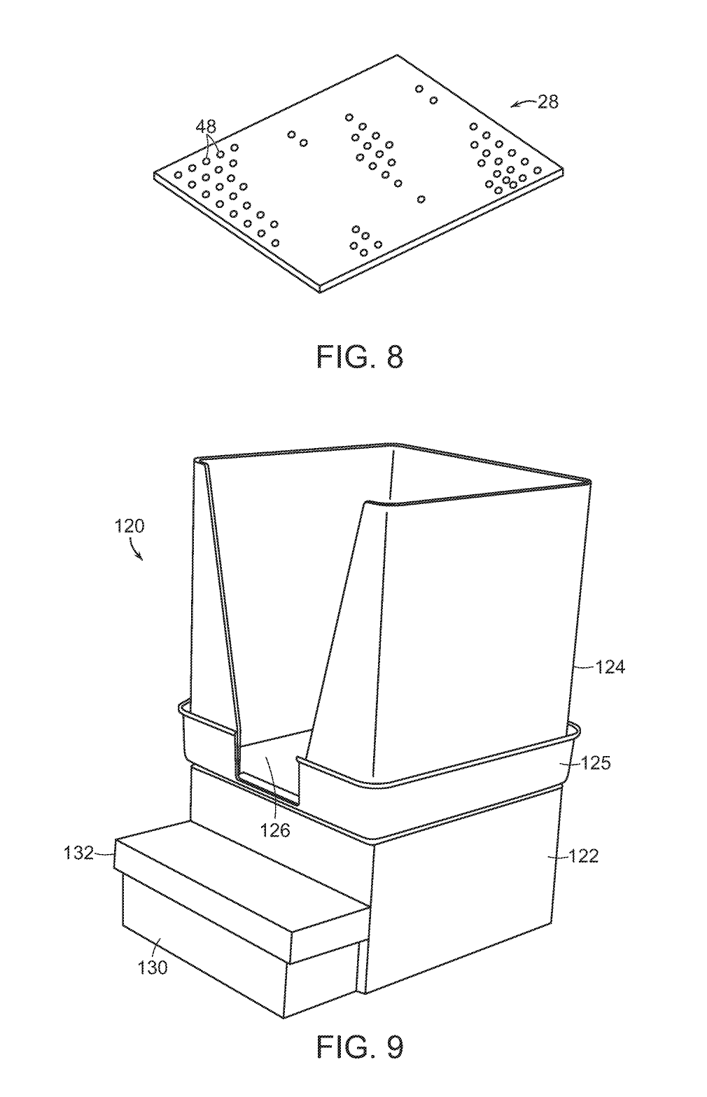

FIG. 8 is a perspective view of floor panel 28. In an embodiment of dimensioned box 20 as noted above, drain pan 26 may be about 55 cm length, 44 cm wide, and about 8.5 cm deep. For such a pan, floor panel 20 may be about 38 cm long and 28 cm wide. A floor panel may have a circumscribing upward-running outer rail (not shown) or other shaping, to give the floor panel a generally concave shape for better retaining litter, particularly when the panel is lifted from the drain pan to discard the litter. See the description below about FIG. 6A

A floor panel may be made of polyethylene, other water resistant plastic, or other material of about 3 mm thick and may have a multiplicity of through-holes 48 which are round or some other shape. The holes 48 have dimensions that are small enough to prevent through-passage of the particles of litter, the use of which is anticipated. In one embodiment of floor panel, round holes are about 2 mm in diameter and spaced apart 4 mm center to center. Less preferably, the floor panel is a solid sheet with space around the edges for down-flow of liquid animal waste.

FIG. 5A shows an alternative embodiment of molded plastic drain pan 126 having a plurality of peninsular-shape lands 146 around the periphery of the interior of the bottom of the pan, and a center island 144.

FIG. 6A is a cross section like FIG. 6, showing another alternative embodiment drain pan 26A with a suspended floor. Floor 28A is concave in shape; there is a perforated bottom which is suspended above the interior surface of the bottom of drain pan 26A by means of at least two opposing side webs 58 that rise up from the substantially flat bottom surface, with lips which rest on the upper edges of the drain pan periphery. There is a space under the floor which allows liquid which flows through the floor panel to run across the bottom of the drain pan to drain port 40A. Preferably, there are four side webs 58, in which case the floor might be characterized as being basket shape. Floor panel 28A may be made of perforated plastic sheet as previously described, or it may be made of a corrosion resisting metal mesh. In still another embodiment of the invention, not shown, the floor rests directly on the bottom of the drain pan and there is either sufficient uneven fit, or texturing of the floor or of the bottom of the drain pan, to enable liquid flow between the underside of the floor and the bottom interior surface of the drain pan.

The optional enclosure which is canopy 24 may be made of a single piece of arch shape material as shown in FIGS. 1, 2, and 4. In one embodiment the sheet material is flexible enough to be shipped as a flat sheet and bent into an arch by the user at the time of assembly of the litter box 20, as pictured in FIG. 1 and FIG. 2. The opposing side edges of canopy 24 slip into slots in the top of base 22, adjacent the opposing side lengthwise lips of the drain pan 26.

In an alternative embodiment illustrated in FIG. 4, for more compact and economic shipment, the canopy 24A is comprised of three flat flexible panels, top panel 25A, and two side panels 25B, which are connected to each other. Preferably, the three panels are nominally the same overall length and shipped flat for efficient packaging in knock-down condition; they are then bent by the user at the time of installation. Alternatively the three panels may be shipped with a preformed curve shape.

Referring to FIG. 4, canopy 24 comprises two like opposing side panels 25B and top panel 25A, shown in curved condition. Top panel 25A forms an overlap joint with each side panel 25B. Two mating cleats 42 are preferably screwed to each other and sandwich the overlap joint portions between each side panel 25B and the top panel 25A. The lower ends of side panels 24B optionally are screwed or otherwise attached to the upper sides of the base, or slip into lengthwise slots in the top of the base, or are shaped in the form of a multiplicity of downwardly extending tabs that are received in spaced apart lengthwise slots in the top of the base.

In another variation, the canopy 24, 24A enclosure above the drain pan may comprise an additional panel, not shown, which closes off the back opening of arch shape curve structure. In a still further variation, the enclosure may be fence-like with an open top, embodied by enclosure 124 in FIG. 9. In FIG. 9 litter box 120 is comprised of base 122, drawer 130, drawer lid 132 and drain pan 126. Fence enclosure 124 fits into collar 125 which is an upward extension of the rim of the drain pan 126 or a separate like-structure. Fence 124 has a substantially vertical back and two substantially vertical sides, and a front opening for animal access.

With reference to FIG. 9, and applicable to other embodiments. An inclined ramp, not shown, may run from vicinity of the opening in the enclosure 124, or the edge of drain pan 126 when there is no enclosure, to the floor that lies outboard of the front of drawer 130, to enable infirm pets more easily to access the drain pan. The ramp could either rest lightly on the outer edge of lid 132, or be slightly spaced apart from it.

Different litters may be used with the invention. A preferred litter that is resistant to urine absorption comprises safflower seeds. If the user wishes, litter which is hydrophilic may be used, it being known that various litters only imperfectly absorb urine.

The invention, with explicit and implicit variations and advantages, has been described and illustrated with respect to several embodiments. Those embodiments should be considered illustrative and not restrictive. Any use of words which relate to the orientation of an article pictured in space is for facilitating comprehension and should not be limiting should an article be oriented differently. Any use of words such as “preferred” and variations thereof suggest a feature or combination which is desirable but which is not necessarily mandatory. Thus embodiments lacking any such preferred feature or combination may be within the scope of the claims which follow. Persons skilled in the art may make various changes in form and detail of the invention embodiments which are described, without departing from the spirit and scope of the claimed invention.

What is claimed is:

1. A litter box for use by a small animal comprising:
a base having an exterior surface, an interior cavity, a top, a bottom, a substantially vertical front, a substantially vertical back, and substantially vertical opposing sides connecting the front and the back; the top having an opening for receiving a drain pan and one of the substantially vertical front, back, or sides having an opening for a drawer and a wall portion above the opening;
a drain pan, set within the top opening of the base, for holding particulate litter and for receiving animal waste and communicating any liquid portion of the animal waste to a container, the drain pan having a drain port and an optional floor panel;
a drawer, slidable to and from said interior cavity of the base from a home position to a pulled out position through said opening at the front, side or back of the base, the drawer having a back end and a front end, the front end forming a portion of the exterior surface of the base when the drawer is in the home position;
a container, positioned within the drawer, having an opening for receiving liquid animal waste;
a funnel, positioned within the drawer, for flowing liquid animal waste from the drain port of the drain pan to the opening of the container; and,
a pedestal for holding within the drawer the container and funnel so the container and funnel can receive liquid waste from the drain pan when the drawer is in the home position.

2. The litter box of claim 1 wherein the container opening comprises a spout and the funnel has an output port in flow communication with the spout.

3. The litter box of claim 1 wherein the pedestal is spaced apart from both the front end and the back end of the drawer, thereby to provide storage space near the front end and the rear end of the drawer.

4. The litter box of claim 1 wherein the front end of the drawer in the home position provides a stepped exterior surface to the base at the front, back or side which has said drawer opening, the front end of the drawer projecting outwardly beyond the substantially vertical surface said front, back or side which is above said opening; further comprising:
a lid hingedly attached to said vertical surface which is above the opening, the lid hingedly rotating upwardly and downwardly, so that in a downward rotated position the lid rests on the outer end of the drawer in the drawer home position, thereby to provide a flat or sloped surface upon which an animal may step to gain access to the drain pan, and so that in an upward rotated position the lid enables the drawer to be moved from the drawer home position to the drawer pulled out position.

5. The litter box of claim 4 wherein the lid has an outer end distant from said hinged attachment location, the outer end having a lip for capturing the front end of the drawer, thereby to keep the drawer from moving from said home position.

6. The litter box of claim 4 wherein the drawer opening in the base is at the front of the litter box.

7. The litter box of claim 1 comprising a floor panel positioned within the drain pan, the floor panel having openings which enable liquid passage therethrough.

8. The litter box of claim 1 wherein the drain pan has a rim which supports the drain pan within the top opening of the base, further comprising is a floor panel having at least two webs that run upwardly to the rim of the drain pan.

9. The litter box of claim 1
wherein the funnel has opposing side legs with tab ends, for supporting the funnel on the pedestal; and
wherein the pedestal comprises a box-like structure having a top with an opening, and slot openings or side edge features for receiving the tabs of the legs of the funnel;
wherein when the drawer is in the home position within the base the funnel is situated beneath the drain port of the drain pan, and when the drawer is in pulled out position the funnel is tiltable away from its flow communication position relative to the opening of the container, thereby to enable removal of the container from the drawer.

10. A litter box for use by a small animal comprising:
a base having an exterior surface, an interior cavity, a top, a bottom, a substantially vertical front, a substantially vertical back, and substantially vertical opposing sides connecting the front and the back; the top having an opening for receiving a drain pan and one of the substantially vertical front, back, or sides having an opening for a drawer and a wall portion above the opening;
a drain pan, set within the top opening of the base, for holding particulate litter and for receiving animal waste and communicating any liquid portion of the animal waste to a container, the drain pan having a drain port;
a drawer, slidable to and from said interior cavity of the base from a home position to a pulled out position through said opening at the front, side or back of the base, the drawer having a back end and a front end, the front end forming a portion of the exterior surface of the base when the drawer is in the home position;
wherein the front end of the drawer in the home position projects outwardly beyond the wall portion of the base which is above said drawer opening when the drawer is in the drawer home position, to provide the base with a stepped front, side, or back;
a lid hingedly attached to said vertical surface which is above the opening, the lid hingedly rotating upwardly and downwardly, so that in a downward rotated position the lid rests on the outer end of the drawer in the drawer home position, thereby to provide a flat or sloped surface at an elevation intermediate the elevation of the bottom of the base and the top of the base, upon which surface an animal may step to gain access to the drain pan, and so that in an upward rotated position the lid enables the drawer to be moved from the drawer home position to the drawer pulled out position;
and, a container having an opening, positioned within the drawer, for receiving liquid animal waste from the drain pan, the container opening in flow communication with the drain port of the drain pan.

11. The litter box of claim 10 further comprising a pedestal mounted with the drawer, the pedestal holding said container at a location spaced apart from the front end or the rear end or both the front end and rear end of the drawer.

12. The litter box of claim 11 further comprising a funnel removably mounted on the pedestal, for channeling liquid animal waste from the drain port to the container opening.

13. The litter box of claim 10 further comprising a perforated floor, resting within the drain pan, for supporting litter and receiving animal waste.

14. The litter box of claim 10 wherein the base is comprised of a rectangular shape bottom portion and a rectangular shape top portion, the bottom portion having three interconnected vertical sides and one vertical opening, the top portion having three vertical sides and one vertical opening, the sides of the top portion shaped to slide over and envelop the sides of the bottom portion with said vertical openings aligned with each other.

15. The litter box of claim 10 further comprising an enclosure circumscribing at least two sides of the top of the base, the enclosure having an opening at the front of the base of the litter box.

16. The litter box of claim 15 wherein the enclosure is a fence-like structure circumscribing three sides of the top of the base, the enclosure having an opening vertically above the location of said drawer front.

17. The litter box of claim 15 wherein the enclosure is an arch shape canopy mounted on the top of the base.

18. The litter box of claim 17 wherein the arch shape canopy is comprised of two opposing side pieces and a top piece, the top piece attached at opposing arch curve ends to a side piece, wherein the canopy is shippable in knock-down condition as separate pieces.

19. The litter box of claim 10 further comprising a quantity of particulate litter positioned on the floor within the drain pan, the litter having non-agglomerating and non-water absorbent properties.
